(19) United States
(12) Patent Application Publication
(10) Pub. No.: US 2004/0133583 A1
(43) Pub. Date: Jul. 8, 2004

(54) system architecture and method for entering and accessing entity data in events accounting

(76) Inventor: Kenneth B. Tingey, Logan, UT (US)

Correspondence Address: Brent T. Winder, Jones Waldo Holbrook & McDonough, Suite 1500, 170 South Main Street, Salt Lake City, UT, 84101-1644, US

(21) Appl. No.: 10/717,294

(22) Filed: Nov. 19, 2003

Related U.S. Application Data
(60) Provisional application No. 60/427,889, filed on Nov. 20, 2002.
(60) Provisional application No. 60/428,015, filed on Nov. 21, 2002.

(51) Int. Cl. G06F 7/00

(52) U.S. Cl. 707/100

(57) ABSTRACT

A method for explicit treatment of event details in a semantic, record-extensible structure. This approach can be characterized as a “Big E, little e” event model of accounting and other enterprise events, wherein a semantic framework is designed to support conventional accounting models while providing a general data management environment in which other models and processes can be integrated in a direct, straightforward, and efficient manner. The present method is intended as a means of integrating event, or events, accounting concepts into an enterprise management model. The present approach focuses on the integration of both relational and hierarchical tools for databases and processes to achieve semantic, linguistic meaning using text and symbolic representations of operational definitions agreed upon and understood by relevant parties.

### PRIORITY INFORMATION

This application is based on, and claims priority to, the provisional application filed Nov. 20, 2002 entitled “METHOD FOR ENTERING AND ACCESSING ENTITY DATA INVOLVING A MINIMUM NUMBER OF TABLES OR ARRAYS”, serial No. 60/427,889, as applied for by inventor Kenneth B. Tingey, and the provisional application filed Nov. 21, 2002 entitled “METHOD FOR ENTERING AND ACCESSING ENTITY DATA INVOLVING A MINIMUM NUMBER OF TABLES OR ARRAYS”, serial No. 60/428,015, as applied for by inventor Kenneth B. Tingey.

### BACKGROUND OF THE ILLUSTRATED EMBODIMENT(S)

Over three decades have passed since events accounting first became an important topic for consideration in the accounting community. Inspired by the writings of Vatter, a noted scholar and author on the subject of managerial accounting, Sorter instituted the events accounting literature, a course of inquiry that has been described as “probably the most sustained and directed area of accounting systems research.” Sorter criticized what he termed a “value-oriented” approach to accounting, offering what he termed an “events” orientation. Of particular concern to Sorter was that events-related data be recorded and maintained in a manner that would allow for use in decision models of many kinds by accountants and others. Principal among Sorter's summary arguments was the admonition to “test whether line by line predictions of events, i.e., sales, cost of sales, etc., are more efficient in explaining the future value of a firm than the use of more aggregated figures such as income.” In other words, Sorter was interested in event details, namely data generated by events that could be readily aggregated and summarized not only for standardized, value-oriented reports based on summary information, but for many purposes that could not be foreseen, that may require manipulation and evaluation of details from the original transactions.

Sorter, however, did not clearly differentiate between a composite activity, which may be defined as an event that could include a number of underlying factors and points of data, and each component of that activity, which can be considered an event in its own right. For example, a traditional accounting entry is by its nature a combination of debits and credits—each of which introduces a type of related, classified data into the system. Each debit and credit is used as the basis for ledgers, journals, and accounting reports after it is created in an original transaction or process. Aggregation and consolidation of accounting information involves transformation of such detailed information. One example would be detailed information with respect to the sale of unique products, each in different quantities, with distinct prices, etc. Such details, or components of the composite business activity, are the kinds of data that would be aggregated and evaluated as outlined by Sorter and considered in greater detail by Johnson.

Perhaps consideration of this distinction between composite events and their detailed components may have even been premature when Sorter and Johnson first considered the event accounting proposition. Nonetheless, in subsequent events accounting literature, there are no clear distinctions between composite events and the detailed characteristics of those component events that form the basis for most accounting methods and reports. Hence, there is a need for more specific consideration of the details of accounting and non-accounting events to provide answers as to how such systems may be improved.

These authors observed that a major negative result of a lack of clarity of data management requirements in the event accounting literature, and in event accounting models, are enterprise-level accounting and business systems that are monothitic, inflexible, and poor representations of the business and accounting models of the organizations that they represent. These problems result in systems that are inefficient, that are not responsive to business needs and compliance requirements, and that are difficult to audit for purposes of regulatory and financial compliance and other forms of evaluation.

### SUMMARY OF THE ILLUSTRATED EMBODIMENT(S)

The present invention relates generally to a method for explicit treatment of event details in a semantic, record-extensible structure. Such record-extensible structures in this treatment would be managed in the form of data housed in database tables or arrays, being a data-driven approach rather than an approach based on compiled or hard-coded software tools. This approach can be characterized as a “Big E, little e” model of accounting and other enterprise events, wherein a distinction between composite events in their entirety and component events that make up such activities is contemplated. This approach is outlined in the context of current developments in eXtensible Markup Language (“XML”) enterprise systems research, including eXtensible Business Reporting Language (“XBRL”), and eXtensible Financial Reporting Language (“XFRL”). Also of relevance is the development of directory service implementations of hierarchical “objects” based on the Lightweight Directory Access Protocol (“LDAP”) standard, representing network-wide models of agents and resources.

Thus, an object of the present invention is to provide a semantic, meaningful framework to support conventional accounting models while providing a general data management environment in which other models and processes can be integrated in a direct, straightforward, and efficient manner. The present method is intended as a means of integrating events accounting concepts into an enterprise management model. The semantic approach to such an objective is intended to focus on the integration of both relational and hierarchical tools for databases and processes as opposed to a strictly database approach to achieve semantic, linguistic meaning using text and symbolic representations of operational definitions agreed upon and understood by relevant parties. Furthermore, the record-extensible approach as outlined herein can substantially reduced database footprints of enterprise management systems, an objective that is in harmony with data structuring objectives, as well as lean, competitive entity models. The current financial credibility crisis has brought heightened statutory requirements for accounting and control systems that can be more readily audited, evaluated, and certified. The current invention would contribute to accounting and control systems with significantly improved data stores and processes to support auditing, evaluation, and certification.

There are several advantages of data-driven semantic management of accounting events based on variable data as opposed to hard-coded, constant structures that require reprogramming or recompilation for changes to be manifest. First, such data-driven implementations allow for integration of data and processes, reflecting models that would otherwise restrict one another, if not conflict with the same. In a data-driven environment, processes can be linked and data used or ignored as varying models dictate. Second, data-driven structures provide environments for dealing with complexity with minimum effort while retaining flexibility. These are features that allow for responsiveness and lean operations by accounting professionals in highly competitive, complex environments. Third, data-driven structures provide for substantially simpler schema requirements. Fourth, such structures allow entities to function more effectively with business and professional service partners in a shared data environment, a critical factor for success today.

A primary feature of the illustrated embodiment(s) is a record-driven, extensible approach that utilizes database records as coding and classification tools in order to provide both semantic accuracy, which is based on shared operational definitions, and flexibility. This feature is referred to herein as a “record-extensible” approach. A record-extensible event accounting structure provides the benefits of data-driven models with a clear means of supporting disparate models and changing requirements using database records within normalized database structure based on the Resources, Events, Agents (“REA”) model.

### BRIEF DESCRIPTION OF THE FIGURES

Features of the present invention as outlined within the summary of the illustrated embodiment(s) will become more evident upon examination of the following detailed description in conjunction with the following figures, wherein like element numbers represent like elements throughout:

FIG. 1 illustrates an entity-relationship view of sample sale and purchase events under an REA structure, as well known within the prior art;

FIG. 2 illustrates a proliferation of tables under the entity-relationship model of FIG. 1;

FIG. 3 illustrates a representation of a database table or array;

FIG. 4 illustrates a thumbnail representation of the proliferation of tables of FIG. 2;

FIG. 5 illustrates a thumbnail comparison of the thumbnail representation of the proliferation of tables of FIG. 4 in relation to examples of ERP-oriented enterprise databases;

FIG. 6 illustrates examples of “Big E” events;

FIG. 7 illustrates examples of “little e” accounting events;

FIG. 8 illustrates examples of “little e” retail sale component events;

FIG. 9 illustrates an example of a “Big E” “little e” breakdown of a hazardous chemical analysis event;

FIG. 10 illustrates a basic REA structure;

FIG. 11 illustrates an expansion of the events of FIG. 10 to include details;

FIG. 12 illustrates a series of event transaction tables created from the event definition tables of FIG. 11;

FIG. 13 illustrates a support model for traditional accounting methods and REA structure of FIGS. 10-13;

FIG. 14 illustrates a series of events transactions of FIG. 13, with a rich store of enterprise data;

FIG. 15 illustrates a sample BigE Definition table;

FIG. 16 illustrates a sample LittleE Definition table;

FIG. 17 illustrates a sample resource table;

FIG. 18 illustrates a sample combined BigE Definition/LittleE Definition report;

FIG. 19 illustrates a sample BigE Transaction table;

FIG. 20 illustrates a sample LittleE Transaction table;

FIG. 21 illustrates a query to create a “Big E” event transaction record from an event definition table;

FIG. 22 illustrates a query to create “little e” event transaction records from an event definition table;

FIG. 23 illustrates a sample inventory ledger materialization derived from component “little e” tables;

FIG. 24 illustrates a sample of cash ledger materialization as derived from component “little e” tables;

FIG. 25 illustrates a sample of Big E, little e definition tables;

FIG. 26 illustrates a sample of a Big E, little e transaction table;

FIG. 27 illustrates a sample of a combined big E, little e definition table;

FIG. 28 illustrates a sample of a combined Big E, little e transaction table;

FIG. 29 illustrates a sample of a combined Big E, little e definition and transaction table;

FIG. 30 illustrates a sample randomized Big E and little e transaction tables; and

FIG. 31 illustrates a sample of a LittleE Transaction table transformed to XML.

### DETAILED DESCRIPTION OF THE ILLUSTRATED EMBODIMENT(S)

For the purpose of promoting an understanding of the principles of the illustrated embodiment(s), reference will now be made to exemplary embodiment(s) that are illustrated in the figures, and specific language will be used to describe the same. It will nevertheless be understood that no limitation of the scope of the claims is hereby intended. Any alterations and further modifications of the inventive features illustrated herein, and any additional applications of these principles, which would occur to one skilled in the relevant art after having possession of this disclosure, are to be considered well within the scope of this invention.

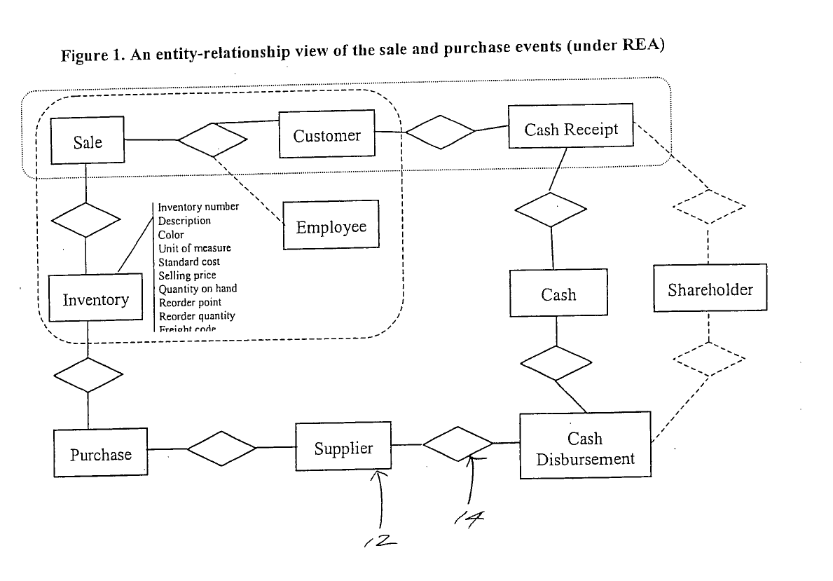

Referring now to FIG. 1, a diagram derived from the prior art, namely Armitage & McCarthy, 1987, illustrates an entity-relationship view of sale and purchase events, wherein many instances of each construct, resource, event, and agent are modeled separately. Individual database tables 12, which may include any construct, resource, event or agent, are depicted in rectangular form, and specific relationships 14 between the database tables 12 are depicted in diamond form. In the present example, the specific relationship 14 represents a relationship between a supplier and cash disbursement. Thus, the specific relationship 14 generally represents a sharing of attributes or fields that may cross over between linked tables. Under the REA model, it is this codification of specific relationships 14 that results in a proliferation of tables. In addition, the events include inclining Sale, Purchase, Cash Receipt, and Cash Disbursement as typical forms of events, Inventory and Cash as resources, and Customer, Employee, Shareholder, and Supplier as agents. Furthermore, when judged sufficiently different from one another under the entity-relationship model as outlined in FIG. 1, multiple tables are created representing differences between sales of different products, different purchase events, inventory of disparate kinds of resources, management of different classes of customers, or other differences between any of the categories listed in FIG. 1, and as extended in a particular case.

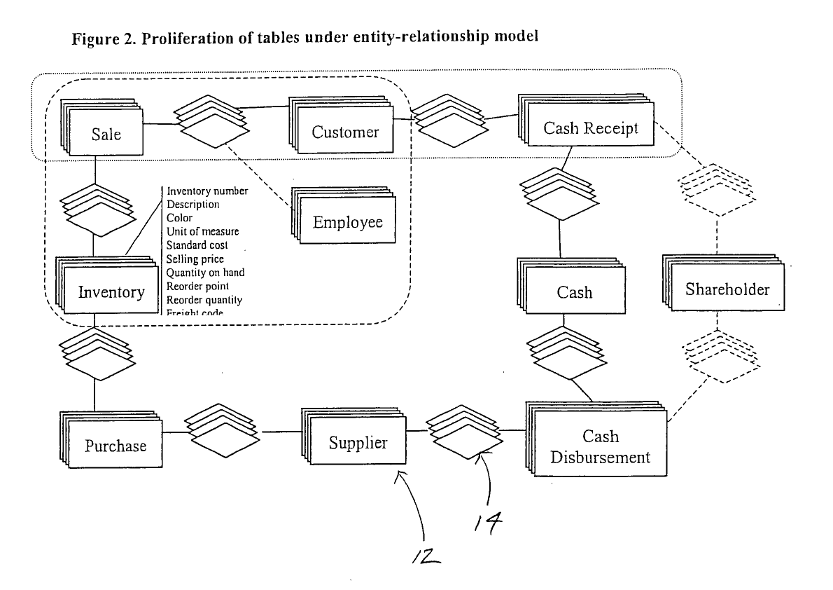

FIG. 2 demonstrates the kind of table proliferation that can occur following the entity-relationship modeling process as encouraged in the traditional REA method, as illustrated in FIG. 1. Multiple changing relationships 14 may result in new sets of database tables 12 to model such relationships.

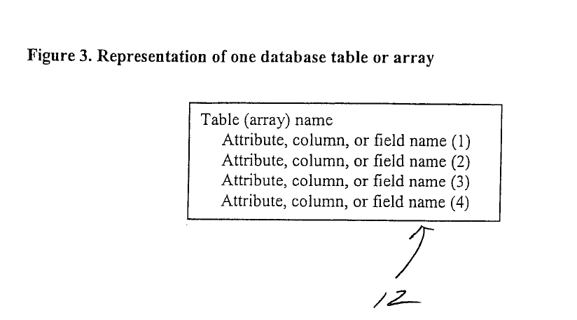

Referring now to FIG. 3, a database table 12 is shown to demonstrates a common method for displaying a single database table 12 or an array of information in which certain attributes, columns, or fields are directly associated with the database table 12 or array of information about a “Big E” or composite event.

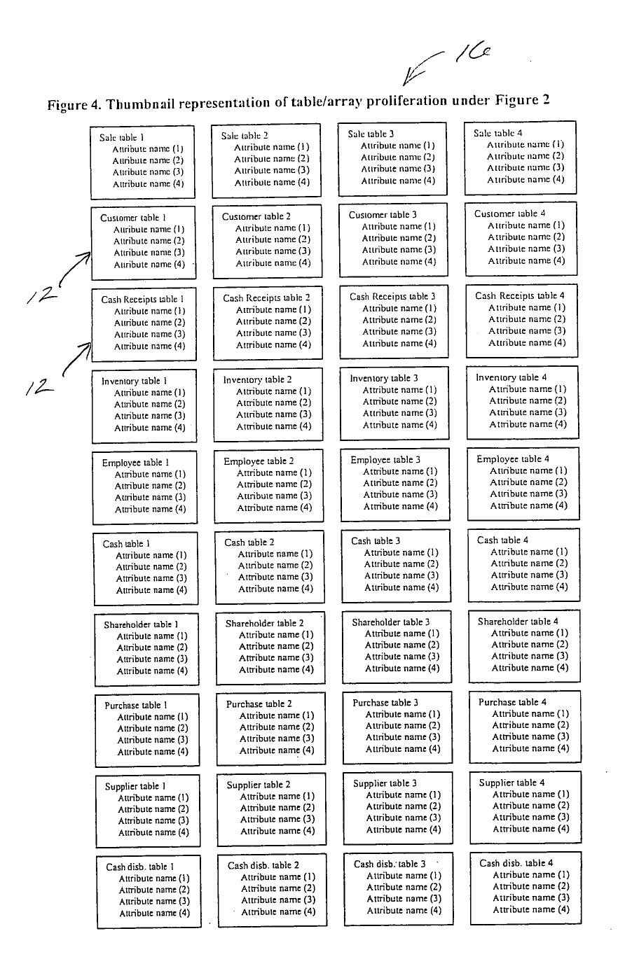

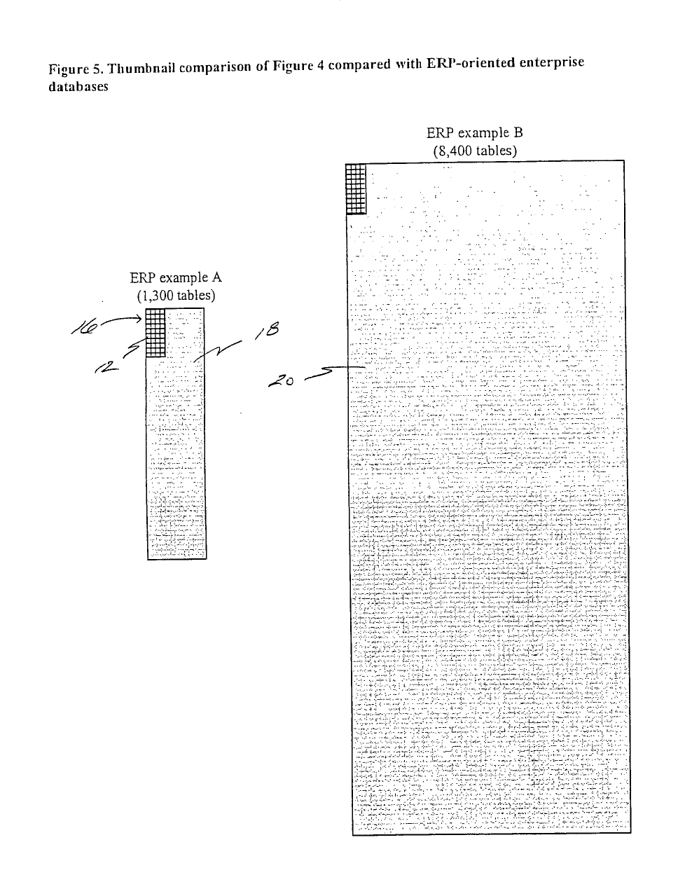

FIG. 4 illustrates the database tables 12 of FIG. 2 in the format of FIG. 3. More specifically, a means of graphically displaying the effect of table proliferation, resulting in a collection of tables 16, in an entity is shown.

Referring now to FIG. 5, a diagram is shown that compares the approximate size of the collection of tables 16 in FIG. 4 with the reported schemas of two major Enterprise Resource Planning (“ERP”) systems 18, 20. Example A includes an entity or enterprise schema 18 with approximately 1,300 tables. Example B compares the forty tables of Exhibit 4 with 8,400 tables of another broadly used ERP system 20. Given that in both cases the total number of database tables 12 represent independent tables or arrays of information, one skilled in the art can appreciate the effort required to understand the structure and composition of such entity or enterprise databases.

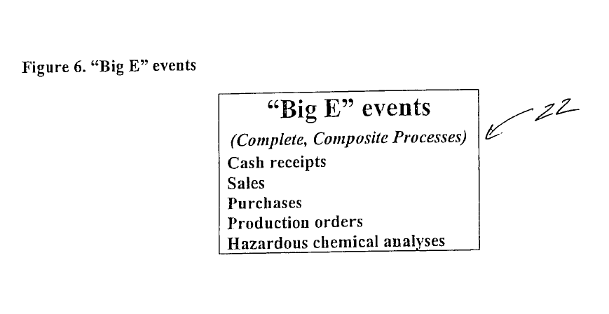

Referring now to FIG. 6, examples of “Big E” events 22 are named and illustrated.

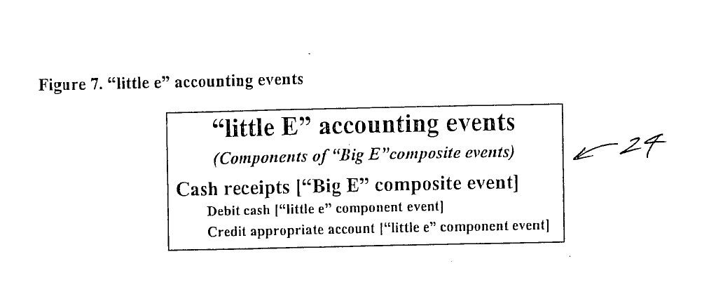

FIG. 7 illustrates some examples of “Little e” events 24, also referred to as component events, which are the specific actions that come together to form the composite “Big E” event 22, as can be seen in the example of a simple cash receipts accounting, shown as a “Big E” event 22, in FIG. 7. The term debit cash refers to a cash receipts event that is a composite accounting event requiring some form of control. More specifically, there are issues that must be considered in recording the receipt of cash. In this simple example, required actions are clear and simplistic, with only two component “little e” events 24. Cash has been accepted and the cash account is debited. Specifically, the act of accepting cash could be a much more complex matter, involving more component “little e” events 24 that make up this simplified composite “Big E” accounting event 22. Conversely, the cash receipts events that are not related specifically to accounting entries could be grouped as part of other linked composite “Big E” events 22, whether accounting or otherwise.

The second component “little e” event 24 pertaining to cash receipts is the act of crediting an appropriate account with the amount received, as also illustrated in FIG. 7. By the same token, crediting the appropriate account could be expanded into a “Big E” composite event 22 of its own, or a series of component “little e” events 24 in the cash receipts “Big E” event 22 if appropriate controls were considered necessary or if the task proved to be burdensomely complex. In this case, the cash debit “little e” component event 24 may be considered as a single part of the composite “Big E” cash receipts accounting event.

Based on the traditional double-entry accounting model, debiting cash without coming to some resolution as to the source of such cash could not be considered a “Big E” composite event 22, given that it doesn't help at arriving at any resolution of the action. Such a result is finally achieved with a satisfactory credit to an appropriate account, completing out the requirements of the “Big E” composite event 22 of cash receipts. To say that a compliant receipt of cash has occurred as a composite “Big E” accounting event 22, detailed knowledge of the two “little e” component events 24, the debit and the credit are required. An effective composite “Big E” accounting event 22 would not have occurred in their absence. The relationship between “Big E” composite events 22 and “little e” component events 24 holds for non-accounting events as well.

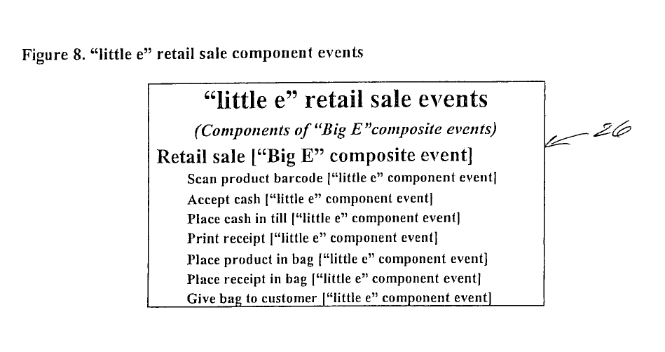

Referring now to FIG. 8, a retail sale could include any number of requirements that would have effects outside of the accounting model. The requirements outlined here presuppose a typical retail situation in which the salesperson follows through with a variety of actions that result in satisfactory conclusion to the sale. In this example, there are activities based on business models established by individuals outside of accounting who have been likely enriched by accountants' advice as to appropriate means of handling cash. The “Big E” retail sale composite event 26 could readily be linked to an accounting cash receipts composite event that might achieve two purposes—the objectives of the cash receipts “Big E” accounting event as well as the details of the retail sale “Big E” non-accounting event. Essentially, the “little e” component events 24 have meaning and importance when they are created as a part of their parent “Big E” composite events 22.

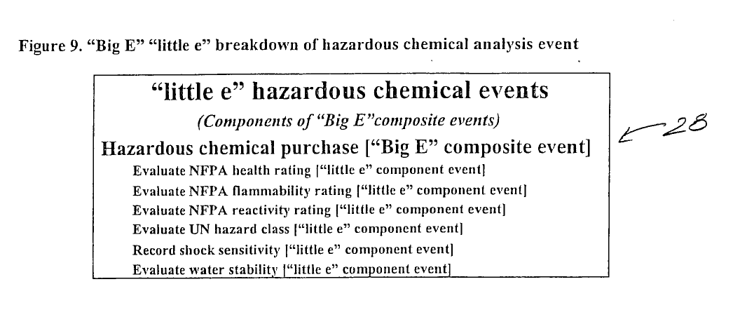

Interestingly, “little e” component events 24, whether accounting or otherwise, typically convey meaning in their own right, long after the original “Big E” events 22 that served to create them took place. Particularly, in the cash receipts accounting “Big E” event of FIG. 7, the “little e” debit to cash combined with other “little e” debits and credits to cash contribute to an understanding of cash balances. The same can be said for the “little e” credit to the appropriate account, which is most likely revenue in the case of a cash retail sale. The utility of this “little e” component event 24 is significant and important in evaluating revenues in a number of ways, independent of the original “Big E” composite event 22 that served to create it. The distinction between composite “Big E” events 22 and component “little e” events 24 can extend to a disparate set of circumstances, as can be seen in FIG. 9.

In FIG. 9, a listing of “little e” component events that could correspond to the purchase of a sample chemical 28 with potentially hazardous properties. The acts of evaluating ratings themselves are examples of potentially confusing distinctions between “Big E” and “little e” events. Evaluations of ratings such as those presented in the example could be as simple as ascertaining the fall of numeric ratings within a range of numbers, arguably a simple task that probably would not warrant “Big E” treatment as a composite process, as is held to be appropriate in FIG. 9 with respect to the entire hazardous chemical purchase process. In this purchase process, consideration of relationships between the figures presented and their interaction and cumulative effects is a significant challenge to be met, once data with respect to each of the component “little e” events 24 is collected and evaluated. Interestingly, such an activity, which is entirely outside the purview of financial accounting, benefits from a model that focuses explicitly on the distinction between composite “Big E” and component “little e” event structures. The same database schema for the accounting events can be used to support accounting and non-accounting events allowing for unprecedented simplicity and for integration of database models supporting many, if not all kinds of events.

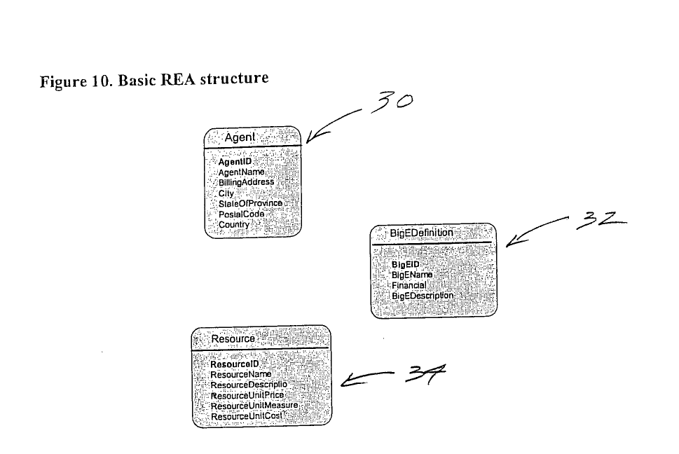

A record-extensible schema for the present invention, which involves database orientation, semantic orientation, and structuring orientation, is represented in FIG. 10. More specifically, FIG. 10 illustrates three tables representing resources 34, events, in the form of BigEDefinition table 32, and agents 30 of the REA model.

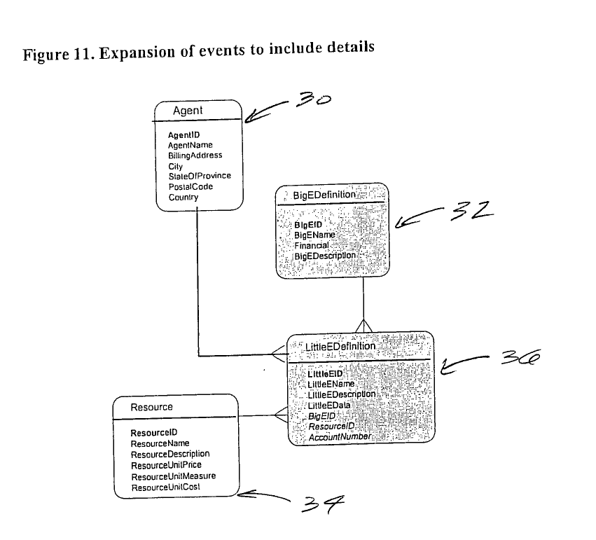

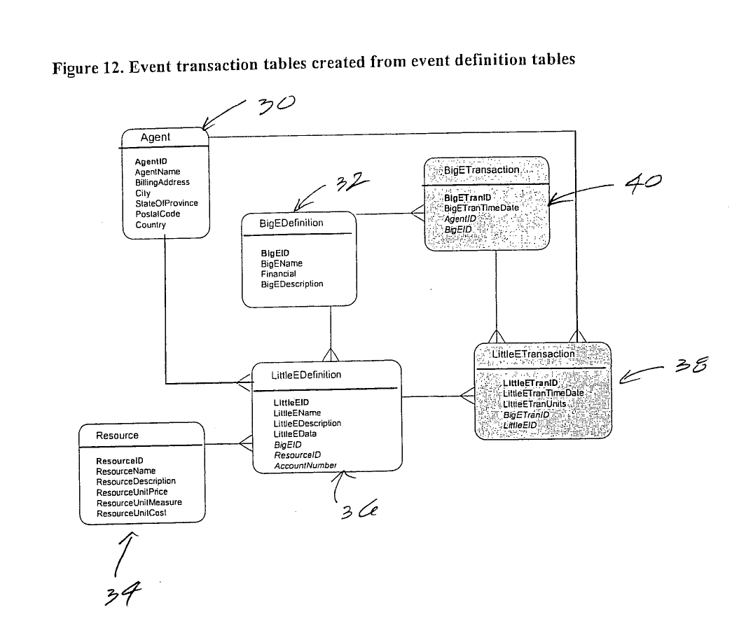

Now referring FIG. 11, the design as shown incorporates differences between “Big E” composite events 22 and “little e” component events 24 using related tables, specifically BigEDefinition and LittleEDefinition, in lieu of handling “little e” components as attributes within the “Big E” composite events table itself. “Big E” composite events can have attributes as well in this model, but dynamic, process-oriented information will be defined and stored in separate component “little e” tables, specifically referred to as LittleEDefinition 36 and LittleETransaction (see FIG. 12 element 38). One major advantage of such a structure is that it does not require that database designers anticipate and account for any and all variations in events structures and requirements. All composite events of all kinds can be classified and stored in the “Big E” event tables 22 and all component events of all kinds can be classified and stored in the “little e” event tables 24.

FIG. 11 further demonstrates a means of expanding on a single composite “Big E” events table 22 into a secondary table specifically designed to house details of events. In this manner, events are differentiated by record-based distinctions in the subordinate LittleEDefinition table 36, which table would store events information details in a “Big E” event or “little e” details structure. Thus, the BigEDefinition table 32 is merged into the composite “Big E” events table 22 and the LittleEDefinition table 36 is merged into the component “little e” events table 24.

With knowledge of the basic schema of the BigEDefinition and LittleEDefinition data structures, accounting professionals, as well as managers, subject matter experts, and process designers can manage both input and outputs into the primary system with no required changes to the underlying database. Event details brought together in this fashion could serve as a basis for managing models of many kinds. Available events details that do not conform to, or that in concept may even conflict with a model in question, can thus be ignored. For example, a record-extensible process as outlined in a “Big E, little e” events model would allow accountants to ignore previous posts in a transaction table, as illustrated in FIG. 12, in favor of subsequent figures considered more substantive.

A record-extensible semantic practice is a departure from the orientation of the REA model in that the basic database schema is not explicitly structured so as to reflect changing perceptions of reality. Reality with respect to resources, events, and agents in this record-extensible framework is to be represented in the data, rather than solely in the structure of the database. This structure is held to be more cost-effective, more efficient, and more practical than would be an attempt to create a single data model that is designed to accommodate and/or serve everybody in the sense that all relationships, entities, and resources have been anticipated by the database designers. One benefit of such a flexible model is that resulting tools for creation and use of event instances and supporting details need not favor one model as in the traditional dual-entry accounting method in lieu of or in conflict with other models.

This record-extensible approach is considered to be compatible with the resource, event, and agent orientation of the REA model. As in database-centric implementations, a record-extensible approach stores data such that each economic event data may be recorded and linked to resources and agent data. Resource outflows and inflows can be similarly supported using a record-extensible model. Management of these relationships with records in data, rather than specifically in the database schema, does not preclude resource, event, agent analysis, and, may also support higher levels of complexity and responsiveness to real-world requirements than could be expected of the original database designs.

In this way, FIG. 12 demonstrates a direct relationship between tables created to define both composite and component characteristics of events. Based on codes and relationships in the BigEDefinition table 32, a BigETransaction table 40 is populated. At the same time, the LittleEDefinition table 36 would serve as a template creating function for a LittleETransaction table 38 that would contain the rich component event data that could serve as primary data for many purposes. Data stores housed within the event transaction tables could get very large—particularly given that the intent of such a record-extensible structure is to include events and event details of all kinds in these transaction tables. Such an architecture brings challenges as well as benefits. Management of large event tables requires powerful querying and data storage facilities—resources that are present in more flexible, low-cost environments than in the past through performance improvements in standalone systems as well as interconnected networks.

One benefit of very large event transaction tables is that their simple, straightforward structure provides a clear, easily understood schematic environment for systems designers as well as systems users. Access to such tables should be restricted by classification type to preserve integrity of event models and maintain system security overall, a subset of the overall business model. Simple events detail transaction records can support the complexity and sophistication by making use of complex classification structures and comparatively simple queries. Based on a structure characterized by a few interconnected event tables as outlined herein, designers and users would not have a difficult time locating data. Such data would be available, classified in atomic, standardized composite and component event detail records.

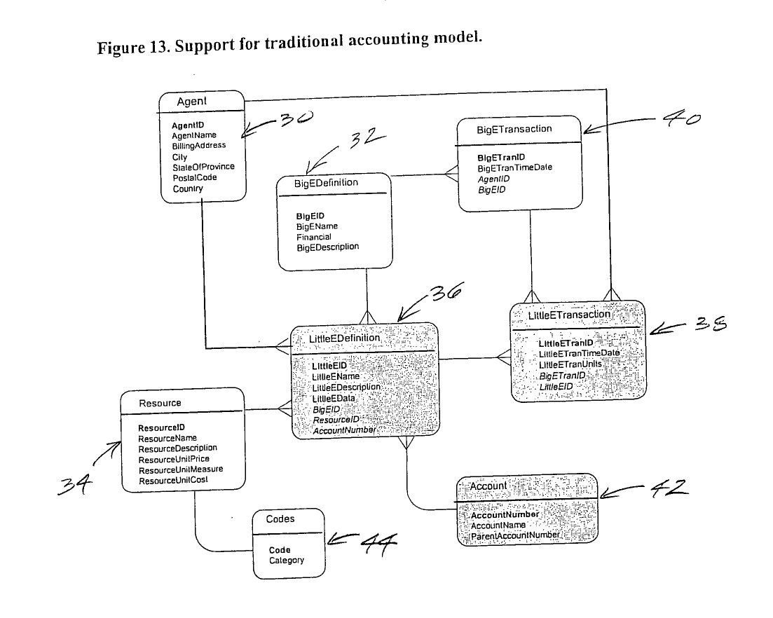

Now referring to FIG. 13, a diagram is shown that demonstrates a means by which the record-extensible approach would support the traditional accounting model with debits and credits, traditional journals, ledgers, and financial statements based on component “little e” events transaction data. Based on the normalized structure of the data, financial statements can be created using query and reporting tools. Based on transactions derived from such event detail records, account 42 balances could be derived by means of queries and summary records. Summary accounting information could be collected and used in essentially the same way as in the past by means of such queries that would not interfere with other accounting-related “Big E” or “little e” events transaction data or other non-accounting, non-financial data. Codes 44 refer to a means of standardizing the classification of resources. For example, in the case of an enterprise making use of the “Big E little e” dynamic, codes 44 may involve a comprehensive taxonomy of acronyms or words that have operational meaning.

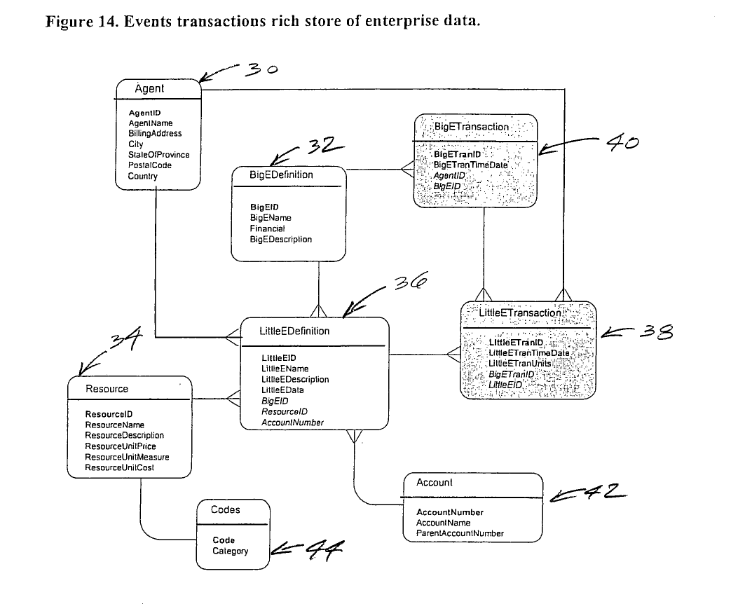

As outlined in FIG. 14, there are challenges to this approach in bringing underlying events data together, but the basic principles are clear. Queries, or codes 44, on data housed in this model could suffer from insufficient data processing resources, because queries based on this model would involve searching tables or arrays with large numbers of records or line items. Among the various ways to meet those challenges, one could be to transfer certain types of data from the primary transaction databases into departmental databases or data warehouses, where such data manipulations could take place on appropriate subsets of the data. Further, data normalization rules could also be relaxed on such transaction tables, allowing for direct queries on single tables with some data redundancy, rather than on complex, resource-intensive joins and queries from multiple tables.

It may be difficult or impractical to design a general purpose schema that will allow for all of the unique requirements of events at the composite or component level. The need for complexity in individual event records can likely be overcome by considering component “little e” event detail records as singular data stores and in not attempting to glean too much information from each “little e” record. An ability to model complexity without first engaging in complex schematic, normalization analysis is one advantage of the proposed event table structure in that it allows for any number of attributes or subordinate points of data without requiring that such details be reflected in the underlying database schema.

Security and stability of data in the proposed architecture are factors in the selection of standardized event summary and detail records. Of course, a record-extensible structure, such as is described herein, is possible only through use of classification and hierarchy establishing tools and concepts along with relational models. Use of both kinds of models are critical to successful implementation of a functional security model. By definition, security itself is a hierarchical phenomenon, namely that rights are granted to individuals and organizations based on some form of classification. Thus, an approach based on hierarchic as well as relational structures is viable to the degree that such tree-based classification systems are available to secure and to organize the data. As an example of how such a record-extensible environment functions, three composite “Big E” events are outlined.

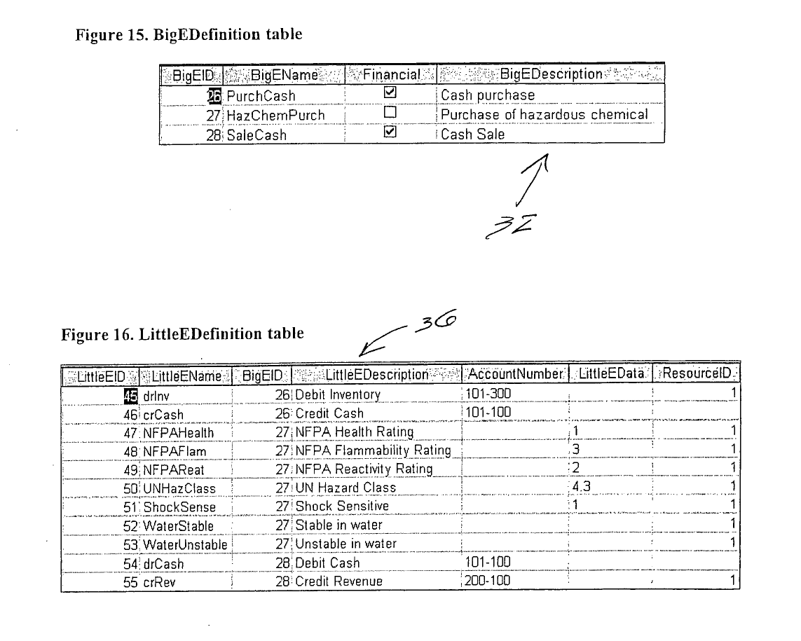

First, now referring to FIG. 15, BigEID line item #26 is a double-entry composite event within the BidEDefinition table 32 that records accounting implications of a cash purchase of materials. This composite accounting event is followed by a non-accounting composite event, BigEID line item #27, which is used to record implications of a purchase of calcium carbide, a hazardous chemical provided for example only. Hazardous chemical information is included as an example of how to incorporate a non-accounting composite event, which is commonly understood as a limitation of traditional accounting systems that is much criticized in the events accounting literature. The third kind of composite “Big E” event, BigEID line item #28, is outlined as a cash sale of the product in question.

Note that the schema of the BigEDefinition table 32 corresponds to the schemas of FIGS. 10-14. As outlined earlier, component information regarding each of these composite events is stored in the LittleEDefinition table 36, as outlined earlier in FIGS. 11-14. This table, as populated in FIG. 16, includes a number of factors for each composite event as can be seen in the third column, specifically the BigEID column, which corresponds to the BigEID column in the BigEDefinition table 32 in FIG. 15. As can be seen, there are two event components that correspond to BigEID line item #26, a debit to inventory, which is LittleEID line item #45, and a credit to cash, which is LittleEID line item #46. Also included in the definition of these component events is the appropriate account number and a resource identification number to point to the item in question. No information is recorded in the LittleEData column, as there is no corresponding requirement for data for this field within the basic accounting model.

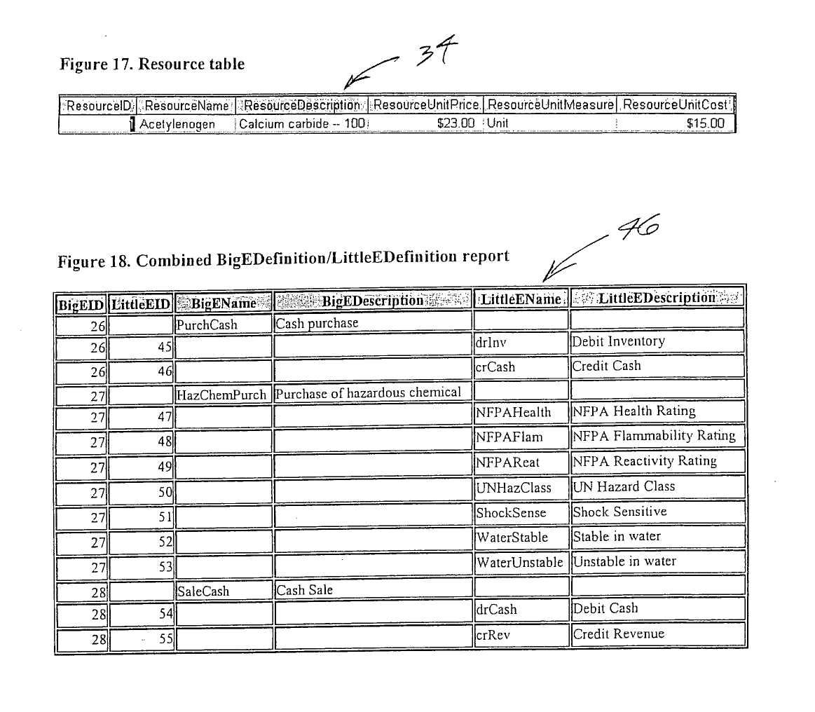

Underlying event components tied to event number BigEID line item #27, namely LittleEID line item #47 to LittleEID line item #53, are non-accounting component “Big E” events and have no corresponding account numbers. They are tied to the resource table 34, given that they are descriptive of that particular resource, or item in inventory as illustrated in FIG. 17.

Referring now to FIG. 18, a combined BigEDefinition/LittleEDefinition Report 46 shows details with respect to the third composite event type, BigEID line item #28, namely LittleEID line item #54 and LittleEID line item #55, which are included along with related financial information, since BigEID line item #28 SaleCash is an accounting-related composite event as is BigEID line item #26, PurchCash. In this simplified model, actual postings of debits or credits could be categorized by positive or negative numbers.

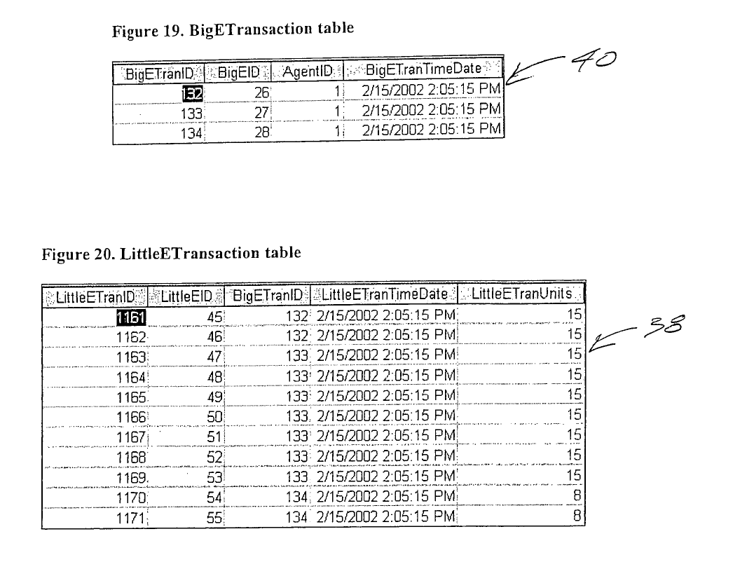

In FIG. 19, the BigETransaction table 40 shows three events, namely BigEID line item #'s26-28, which can be seen with their corresponding details.

Now referring to FIG. 20, the LittleETransaction table 38 shows transaction records that are created based on the information found in the BigEDefinition table 32 and the LittleEDefinition table 36. Based on the presumption that fifteen units of a sample resource are purchased and eight units are sold, the resulting event transaction records are created as shown.

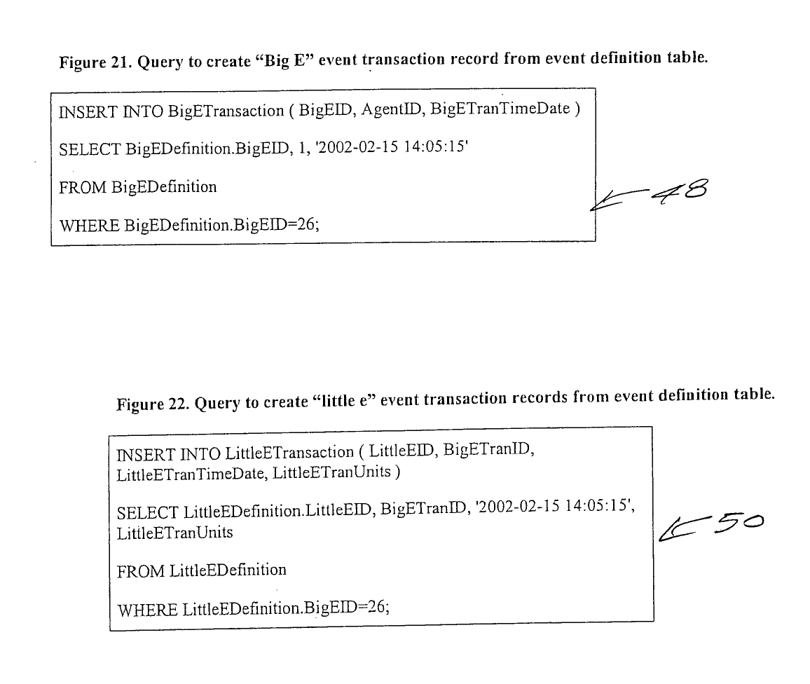

Now referring to FIGS. 21 and 22, FIG. 21 demonstrates a query that was used to create a “Big E” event transaction record 48 for the “Big E” purchase event BigEID line item #26; and FIG. 22 outlines a query used to create a “little e” purchase event transaction record 50 of LittleEID line item #45 and LittleEID line item #46. Note that the second query lacks information to determine BigETranID numbers and LittleETranUnits, both pieces of information being asked of the user as the queries are being performed. Both contain minimal information, but sufficient to generate aggregate and summary reports based on any number of models. In this case, the time/date stamps of BigETranTimeDate and LittleETranTimeDate may prove redundant in that they occurred at the same time. In the case of an event that spans time, the LittleETranTimeDate may convey information about the occurrence of each “little e” event that is meaningful. Such template establishing functions can be carried out in a variety of ways, including by means of programmed, compiled applications as well as through scripts, rules engines, or other triggering mechanisms. In this case, queries 21, 22 were applied to the database to progressively create “Big E” composite transaction events 22 and “little e” component events 24.

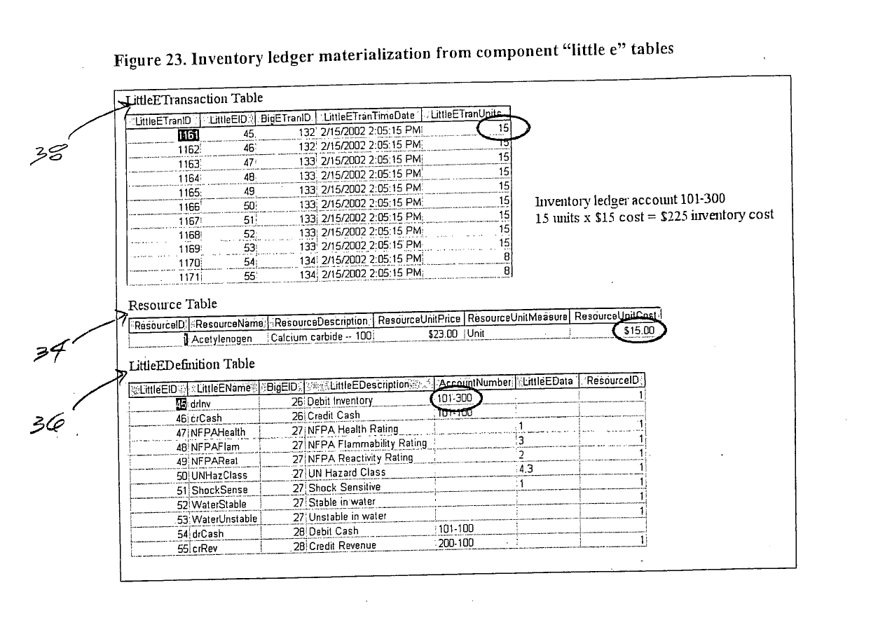

Now referring to FIG. 23, materialization of accounting reports as well as non-accounting model requirements can be drawn from the event transaction records as represented in the LittleETransaction table 38 due to the normalization process conducted earlier. Given LittleEID information, for example, inventory adjustments and cash ledgers, along with other financial information, can be materialized based on AccountNumber and ResourceID data found in LittleETranID line item #1161 of the LittleEDefinition table, coupled with ResourceUnitPrice information for ResourceID line item #1 in the Resource table 34 and the LittleEID line item #45 of the LittleEDefinition table 36 as outlined. Similar calculations based on LittleETranID line item #1162 can be used to determine the amount paid for generating appropriate figures for the cash ledger.

Furthermore, hazardous chemical information, as accessed by means of the LitteEDefinition table 36 by LittleEID numbers, can be used to support non-accounting models as they would correspond with various fields of endeavor, from environmental compliance in this case to disclosure and safety and health, for example.

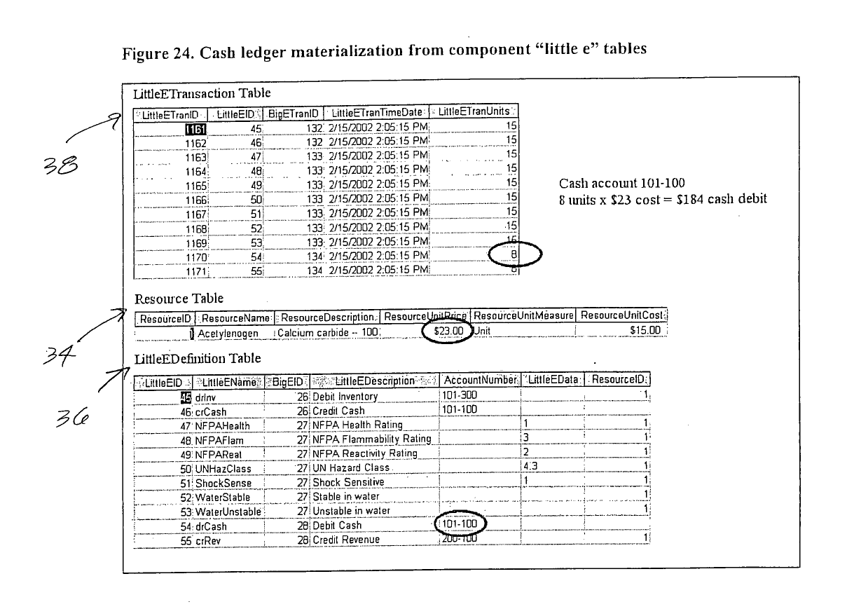

Now referring to FIG. 24, cash ledger or journal information may be derived from the same fundamental component “little e” tables as were displayed in FIG. 23 to generate inventory ledger entries. Based on LittleETranID line item #1170, as tied to LittleEID line item #54 in the LittleEDefinition table 36, it is possible to use AccountNumber line item #101-100 of the LittleEDefinition table 36, coupled with ResourceUnitPrice information for ResourceID line item #1 in the Resource table and the LittleEID line item #45 of the LittleEDefinition table 36 to calculate and record ledger and journal information. The core store of data with respect to the three composite events in question, the LittleETransaction table 38 is a powerful source of component event data that can provide multifunctional benefits within an accounting environment and elsewhere. Further, resulting data can be shared in an open, collaborative environment with a minimum amount of effort, as long as collaborative partners make use of compatible semantic frameworks; that is to say that, they refer to resources, events, and agents and their relationships using the same or compatible operational definitions and class terms.

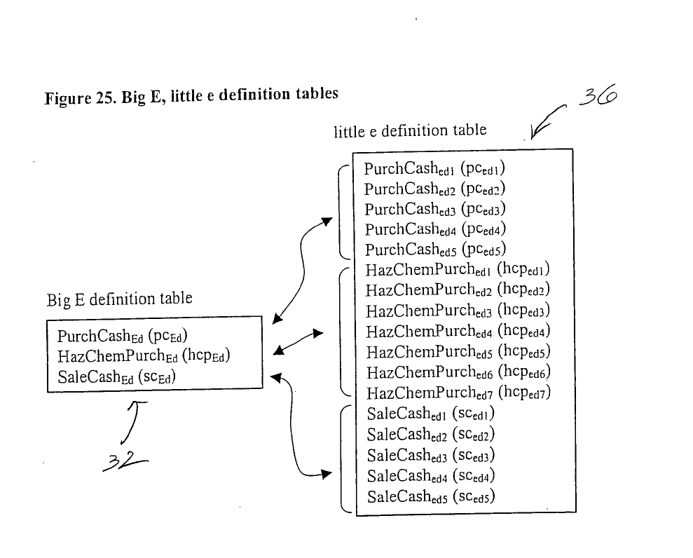

FIGS. 25-30 illustrate a series of tables created to further clarify and represent the basic data structures. FIG. 25 outlines the relationships between a BigEDefinition table 32 including three examples from FIGS. 15 and 16. In this example, five “little e” component events 24 correspond to the PurchCash “Big E” composite event 22, identified as pc_{ed1} to pc_{ed5}. HazChemPurch and SaleCash. The other “Big E” composite events 22 contain four and nine “little e” component events 24 respectively.

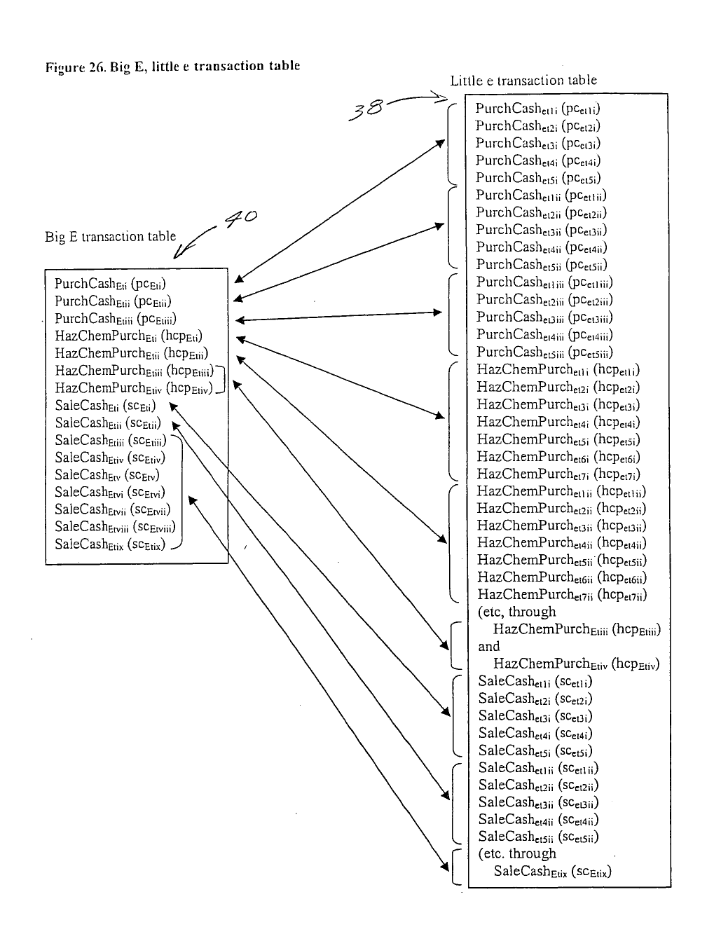

Similarly, FIG. 26 outlines relationships between “Big E” transaction events and little e transaction events in separate tables or arrays. Each little e event in the LittleETransaction table 38 corresponds to one “Big E” transaction record. In the case of the first five records in the little e transaction record, namely pcₑₜ₁ᵢ-pcₑₜ₅ᵢ, they all have pcEti as the parent “Big E” transaction record.

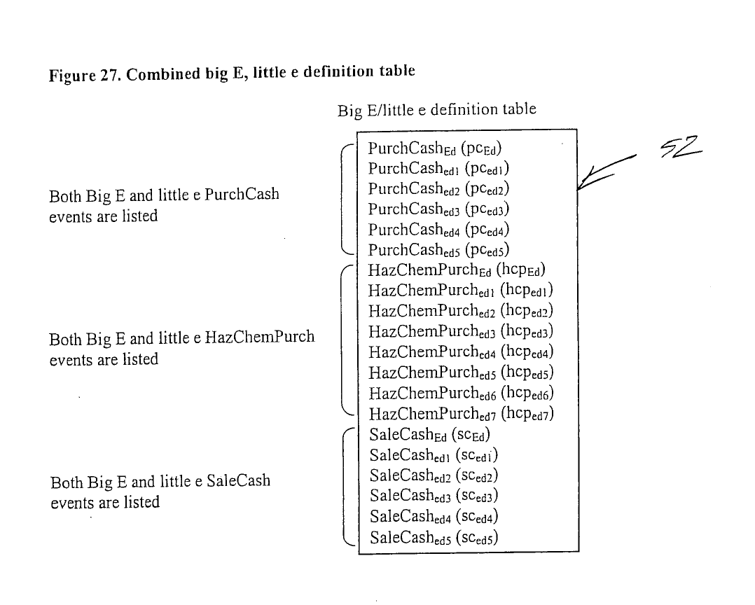

FIG. 27 demonstrates an ability to combine Big E and little e definition tables or arrays into one table, the combined BigELittleEDefinition table 52. In the example, PurchCash_{Ed} (pc_{Ed}), the parent Big E definition table, is linked to five little e definition records, also listed in the “Big E/little e definition table.” HazChemPurch_{Ed} and SaleCash_{Ed}, the other two Big E records in the definition table, have seven and five little e records, respectively.

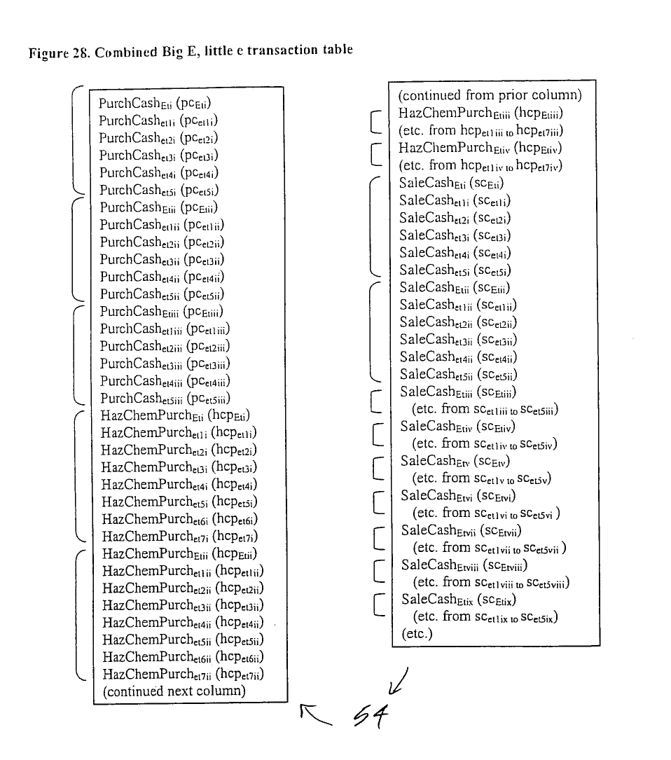

FIG. 28 shows a similar combination of Big E and little e tables for event transactions in a combined BigELittleETransaction table 54.

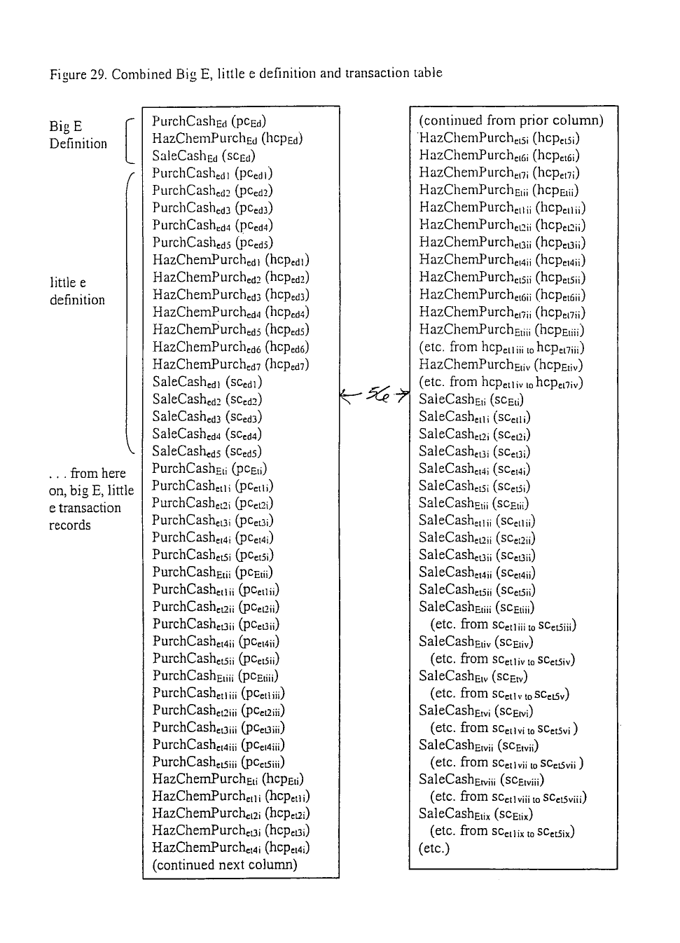

FIG. 29 outlines a combination of both event definition and event transaction records for both Big E and little e events. This is the ultimate form of integration, allowing entity events to be combined into one table or array called a combined BigELittleEDefinition and Transaction table 56.

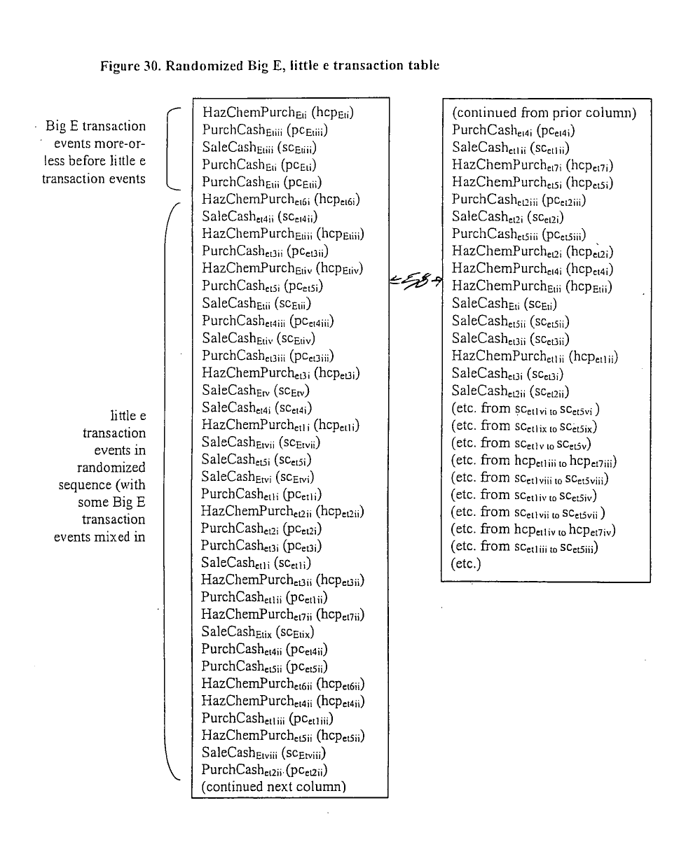

Now referring to FIG. 30, a diagram is illustrated that demonstrates a possible randomization of Big E and little e event transactions within a combined event transaction table 58, outlining the flexibility of this approach, allowing data to be recorded in any apparent order, with the exception that event definition entries would have to be created before corresponding event transaction records could be created. Each transaction event can be queried and sorted as needed, allowing for capture if real time information regarding details of the “Big E” composite events. “Big E” and “little e” definition tables may be integrated with transaction in a semi-random fashion. Specific “Big E” and “little e” definition events precede transaction events in the tables or arrays.

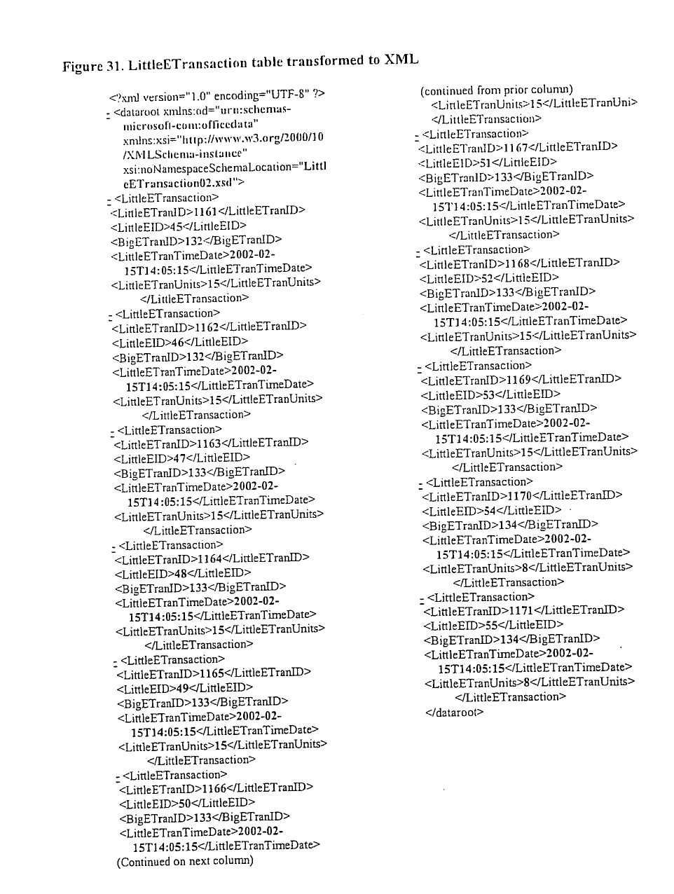

As can be seen in the XML rendering of the data in the LittleETransaction table 38 in FIG. 31, rich information can be shared as long as collaborative partners share codes and classification structures, which are also referred to as operational definitions. In fact, all three of the events in question are based on the same XML schema, as was the case in their relational database structure. Such simplicity, supporting complex sets of relationship as represented by the diversity of data housed in individual event detail transaction records can serve to support the requirements of lean, quality-oriented operations.

Description and Definition of Terminology

The following definitions of particular words as discussed in the present disclosure are not intended to limit the scope of the accompanied claims. Specifically, the following definitions are not to be construed as the only source of understanding for the following terms and concepts, and other standard and customary definitions are to be taken into consideration in determining the meaning of these words.

The word “entity” generally may refer to a whole genre of words. For example, entity could mean a whole business enterprise, or only a division or department of that business enterprise. It is also contemplated that entity refers to government organizations, clubs, not-for-profit organizations, groups, areas of studies, libraries of data, areas of knowledge, statutory and regulatory information, religious affiliated information, economic models, theories of knowledge, economic consortia, or any other gathering of data that is of interest to mankind no matter how finely divided or comprehensive in its collection.

One skilled in the art will realize that the illustrated embodiments discusses the use of the word “operational definitions” to signify a broad concept of the wording. For example, it was illustrated that cash receipts was an example of a composite event, while debit to cash and credit to account are examples of component events. However, a skilled artisan will understand that there are infinite examples that may exist. Specifically, and by way of example only, there could be composite events of chemical analysis, dollars raised, tax laws, research methods, ontologies, and other related examples. These would be followed by component events of steps to perform the chemical analysis, lists of where dollars were raised, specific tax laws, lists of research methods, listing of various ontologies such as medicine, engineering, and food science.

The word “template” may generally be considered to be a type of format or blank document that provides places for a user to fill in information regarding several questions on one form. This method may be viewed as a single depository of information, where answers or data are delivered from the user to the database or table. Additionally, in the current application, a template may also be a series of questions or requests for data that are presented one at a time for the user, which are then delivered to the database or table. However, in a broader sense of the definition, a template will contain a predefined set of data and list of questions to be answered by a user. Thus, when a user accesses the template, the predefined set of data will be automatically entered into the database or table, and other data will need to be provided by the user. Thus, this type of template works much like a blueprint for creating entries in a database or table. It is noted that the creation of a template is also process by which operational definitions of the event are being stored or recorded.

A distinction is made herein between composite events in their entirety and elements that comprise the components of such events. Events in their entirety, which are composite events, are referred to as “Big E” events. Examples of “Big E” events are outlined in FIG. 6. “Big E” events can be considered as collections of actions or characteristics that together provide some level of finality or closure, and that have some logical connection to a beneficial outcome for the composite or complete event or process. As listed, a retail sale of a product could involve a logical series of interactions leading to a purchase decision as well as to a transfer of payment or a transmittal of the product in question.

Each element of a composite activity, which are herein represented as the “little e” components of the Big E event, would not be considered analogously to the activity in its entirety—such as the composite event of achieving a successful sale. By the same token, Big E composite events could include purchase processes (requiring a set collection of activities for successful completion), such as cash receipts events, engaging in production orders, or analyzing and evaluating hazardous chemicals. Each has a related series of little e component actions that come together to form a satisfactory conclusion.

Each little e component is representative of a singular or granular fact expressed in numeric or textual form. A single ‘little e’ fact stands on its own with respect to the “Big E” composite event or activity of which it is a part. While a string of ‘little e’ component events can be organized in logical succession to support a desired composite outcome, ‘little e’ component events do not convey completion of a desired activity, only a part of some activity that in its entirety is outlined by the structure of its parent ‘Big E’ event. Upon completion of a desired activity, namely a ‘Big E’ composite event, individual instances of ‘little e’ component events may be compared, aggregated, or otherwise evaluated, with resulting conclusions being made with respect to such comparative or additive data. For example, a common accounting ‘Big E’ composite event associated with a sale of services could be simplified to represent a receipt of cash and a recording of associated revenue. In accounting terms, such a transaction would be composed of two actions, a debit to cash to record the receipt of cash and an equivalent credit to revenue to record the nature of the transaction. In ‘Big E’ ‘little e’ terms, the overall transaction, the ‘Big E’ event, would be the overall composite transaction, cash receipts. The first of two ‘little e’ component events would be the debit to cash, the second the credit to revenue. Subsequent to the transaction in question, data from similar ‘little e’ events could be compared.

Additionally, it is useful to understand that the term “Big E definition table” generally refers to the idea of having a single table or array that contains operational definitions of the composite events. In other words, a template is being created and stored for later use in the Big E transaction table. This actually is a way of creating a template for entering data into the Big E transaction table, defined below. Generally, it is best to design the Big E definitions table to have definitions with a minimum number of columns, fields or attributes, which are needed to clearly record in the Big E transaction table that a specific and unique composite event has taken place. Typically, the number of columns, attributes or fields optimally 1 to 10 for average applications.

Dependent upon and related to the Big E definitions table is the “little e definition table.” The little e definitions table generally refers to the idea of having a single table or array that contains operational definitions of component events. Again, in other words, a template is being designed to be used for entering data into the little e transaction table. Like the Big E definitions table, the little e definitions table is designed to incorporate a minimum number of columns, attributes or fields. However, because little e events are more descriptive, unique, or fundamental, a few more columns, attributes or fields will be needed. Typically, a likely number of columns, attributes or fields is optimally 10 to 30 for average applications.

The “Big E transaction table” generally refers to the idea of having another single table or array that is designed to be used by a user to record all composite events in real time of an entity. In the Big E transaction table, the first step in recording an event is for the user to search the Big E definitions table to access the specific template that was created and retained in the Big E definitions table. Structured Query Language (“SQL”) is a typical way to query the definitions table to find the specific template that was created for a specific composite event, and to create the Big E transaction record of the composite event needing to be recorded. Once the appropriate template is located, SQL will take the prerecorded data from the selected composite event template and automatically download that data into the Big E transaction table. Additionally, the template will be prompted for real time data that will also be downloaded or entered into the Big E transaction table.

The “little e transaction table” generally refers to the idea of having another single table or array that is designed to be used by a user to record all component events in real time of a just identified composite event, such as from the Big E definitions table, of an entity. The first step in recording an component event in the little e transaction table may be for the user to search the little e definitions table to access the specific templates that were created and linked to the appropriate Big E composite event. SQL is again a typical way to query the definitions table to find the specific template that was created for a specific composite event and to create the little e transaction record of the component event needing to be recorded. Once the appropriate template is located, SQL will take the prerecorded data from the selected component event template and automatically download that data into the component, or little e transaction table. Additionally, the template will be prompted for real time data that may also be downloaded or entered into the little e transaction table.

It is critical to note that the use of all the definitions and transaction tables discussed herein is specifically designed to incorporate an unlimited number or rows, also referred to as lines or records, in a table or array. This has the advantage of leveraging computer processing power, memory, and query capabilities for managing, collecting, and accessing an almost infinite number of entries, lines, or records in arrays or tables that are designed with only a minimum number of columns, attributes, or fields. This allows users of the database, table, or array to easily manage the system with only a familiar knowledge of the operational definitions initially established to define the unique Big E and little e events.

Variations of the Illustrated Embodiment(s)

It is noted that the previous discussion regarding the four tables, namely the Big E and little e definitions and transactions tables, can be easily modified by one skilled in the art. For example, both definitions tables could be combined into one table, and both transactions tables could likewise be combined into a single table. Thus, there would be two functional tables for defining and recording all events of an entity. Additionally, it is equally contemplated by the present inventors to utilize a single table for all four tables. In this fashion, both definitions tables and both transactions tables would be combined as one single table. In other words, all definitions and transactions data would operate out of one table or array.

It is also noted that one skilled in the art would contemplate entering the data into the four tables in a flexible fashion. Specifically, they would typically hold all the data in temporary memory until all of the composite or component event data has been collected or evaluated, and then that data would be downloaded to the appropriate table all at once. However, it is contemplated to be within the scope of the present invention to enter the definitions first, then enter the transactions data into the transactions tables in a logical sequential order. This is where the little e component events would follow one after the other in a sequential order. Additionally, it is contemplated to have innumerable real time events entered into the transactions tables and/or definitions tables almost simultaneously. In the past it would be thought that this model would at the least result in a complete backlog of processing of the event data, and at most will result in a very chaotic table or data organization, since all the data will be almost appearing in a random fashion. However, by allowing any transaction composite or component event records to be entered into the transactions tables in any order relieves the potential for trouble since the table data can be easily located and used by a user using known query and sorting techniques. In other words, if the data is recoverable no matter how it is placed into the tables, then it is not important to have a strict sequential schema.

In terms of variations of the ‘little e’ definitions, all of the ‘little e’ debits to cash could be compared to all other ‘little e’ debits to cash, and other ‘little e’ composite events that would have effect on cash that were controlled by other ‘Big E’ events to determine the level of cash in the organization at a point in time. By the same token, the ‘little e’ credits to revenue could be compared with other ‘little e’ credits to revenue from “Big E’ composite events of the type cash receipts to determine the total amount of revenue for a period. Furthermore, the ‘little e’ component events could be studied, evaluated, aggregated, or otherwise used by system users for purposes that were not thought of by the architects of the original ‘Big E’ cash receipts composite event that was used to create them. Similar comparison and use of component ‘little e’ data could be used for purposes within the accounting model or for any other purpose of the entity based on the same ‘Big E’ ‘little e’ structure.”

Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in the number of supporting tables, queries, or techniques, amount and type, such as encrypted, of data entered, supporting systems, general form, function, and manner of operation, assembly, and use may be made, without departing from the principles and concepts of the invention as set forth in the claims.

Remarks Regarding the Illustrated Embodiment(s)

The “Big E, little e” approach described herein is based on a desire to achieve the main objectives of both the REA and the REE models. Known theories and arguments for semantic accuracy, reflecting real-world conditions, are considered to be of critical importance. By the same token, it is held to be important that ongoing events accounting practices not upset the traditional model by abandoning the use of revenue and expense accounts in the recording of accounting events. As has been demonstrated, the “Big E, little e” structure can support multiple valuations in an environment that supports multiple models without abandoning the double-entry paradigm.

Double-entry and accounting artifacts aside, known approaches have been highly skewed toward composite events in their totality, accounting and otherwise, without specific concern for the design and management of their details or components in a direct, efficient manner. As viewed from a “Big E, little e” perspective, traditional focus is on “Big E” composite events rather than to specifically include “little e” component events, or the details of accounting activities. The typical practice within the REA model is to include each “Big E” event as a separate entity, or table, in the structural schema of a database. This requires database design activities in advance of and to accommodate each and every detail, herein identified as the “little e” components of such events. The establishment of composite “Big E” events as singular entities in a relational database structure requires considerable initial design effort, presupposing relationships between and among any and all of these three fundamental factors. Thus, an environment that depends wholly on relational database tools to provide semantic structure imposes a need to map out any and all associations in advance by database designers. For example, sale-oriented events in a database-only semantic structure would of necessity need to be designed and managed separately from purchase events, accounting events, even other, distinct sale events. Attributes representing details of such events would have to be set up in advance by database designers in order to support unique requirements of each event, making collaboration and modification to meet changing, complex, knowledge-based requirements difficult to conceive of and to carry out. Such flexibility would be further constrained as database implementations become more complex and as the number of such unique events grows, ultimately leading to a proliferation of database tables and relationships between the tables.

Current enterprise database structures, following a tradition of creating unique new database entity or table structures for virtually every event or process, lead to thousands, even tens of thousands of data structure tables, not to mention the numbers of individual attributes that come together to distinguish and differentiate such events in each table. The prior art does not provide for continuous access to all of the information contained in the database, nor does it allow users to apply the data and database structures to support their various models.

The present approach is integrated in nature, designed to take advantage of the benefits of relational, hierarchical, network, and object-oriented paradigms based on an understanding of the relative strengths of these models, the requirements of next-generation, Internet-enabled requirements of accounting and enterprise systems, and the relative capabilities of underlying enabling technologies. In short, a generally recognized premise of the present invention is that relational and hierarchical tools are best employed when integrated in a fashion that allows for maximum flexibility, particularly when accounting and enterprise, or entity, functionality can be supported using record-extensible tools. Generally in supporting a distributed environment, the recommendation is focused on the power of large-scale database, directory, data warehouse, and operating system capabilities brought on by powerful server environments. Furthermore, in some cases, database applications may be foregone in favor of primitive management of arrays and pointers using primitive operating system and hardware resources. Thus, system recommendations are based on the assumption of powerful relational database and system resources, possible clustering, grid computing, and use of integrated database and operating system environments in lieu of distributed database architectures, particularly with respect to mission-critical, transaction-processing events. Within the present system, users may easily and creatively aggregate data to the database without conflict with other concurrent users.

Ultimately, application of a semantic record-extensible approach to events accounting requirements provides a means of supporting traditional accounting requirements while providing for additional accounting and non-accounting models. Such an approach can make use of the basic tenets of the REA model, using record-extensible design to complement relational database structures with regard to resources, events, and agents with a substantially reduced database footprint when compared to existing enterprise and ERP implementations. In this way, semantic modeling can occur using classification trees and coding patterns supported by simpler relational schemas and data models than is the standard of practice. Simplified transactions as outlined above can also inform management of existing legacy transaction data. Furthermore, record-extensible models based on the resource, events, and agents rubric of REA, such as the record-extensible events accounting and hazardous chemical models outlined herein may efficiently incorporating XML, a hierarchical standard for managing data in networked, collaborative environments, as well as directory services, a popular hierarchical data model for managing resources and agents on a network.

What is claimed is:

1. A method for managing and collecting data regarding an entity, the method comprising the steps of:
a. creating a definitions table;
b. populating the definitions table with operational definitions of entity events;
c. creating a transaction table and linking the definitions table thereto so that entity transactions will only be entered using the operational definitions; and
d. populating the transaction table with real time entity events using the operational definitions.

2. The method of claim 1, wherein the definitions table and the transaction table are combined into a table.

3. The method of claim 2, wherein the operational definitions are descriptions of business events.

4. The method of claim 3, wherein the business events are represented by acronyms, words, concatenated words, truncated words, or symbolic representations.

5. The method of claim 1, wherein the step of creating a definitions table creates only a single definitions table.

6. The method of claim 1, wherein the step of creating a transaction table creates only a single transaction table.

7. The method of claim 1, wherein the step of creating a definitions table creates a single composite definitions table and a single component definitions table.

8. The method of claim 1, wherein the step of creating operational definitions further comprises the steps of:
a. creating an entity event name; and
b. entering the entity event name in the definitions table.

9. The method of claim 8, where in the event name is cash receipts.

10. The method of claim 1, wherein the step of creating operational definitions further comprises the step of:
a. creating an entity composite event name and at least one entity component event name that is related to the composite event name; and
b. entering the entity composite and component event names in the definitions table.

11. The method of claim 10, wherein the step of entering the entity composite and component event names in the definitions table further comprises:
a. entering the composite event name into a composite event definitions table; and
b. entering the component event name into a component event definitions table.

12. The method of claim 10, wherein the entity composite event name is cash receipts and the entity component event names are debit cash and credit account.

13. The method of claim 1, wherein the step of populating the transaction table further comprises the steps of:
a. performing a query on the definitions table to find the operational definition about a specific entity event about to take place; and
b. entering real time data about the specific entity event into the transaction table using the operational definitions identified for the specific entity event.

14. The method of claim 10, wherein the step of populating the transaction table further comprises the steps of:
a. performing a query on the definitions table to find the operational definition about a specific entity event about to take place; and
b. entering real time data about the specific entity event into the transaction table using the operational definitions identified for the specific entity event.

15. The method of claim 11, wherein the step of populating the transaction table further comprises the steps of:
a. performing a query on the composite definitions table; and
b. entering real time data about the specific entity event into the composite transaction table using the operational definitions identified for the specific entity composite event.

16. A method for entering and accessing entity data in events accounting, the method comprising the steps of:
a. creating a first set of individual database tables;
b. displaying specific relationships between the database tables;
c. proliferating the database tables and specific relationships between the database tables in multiple form;
d. creating a second set of individual database tables to model the multiple form of specific relationships;
e. graphically displaying the proliferation of database tables and specific relationships via event transaction records; and
f. materializing accounting reports as well as non-accounting model requirements from the event transaction records.

17. The method of claim 16, wherein the database tables are populated with information pertaining to constructs, resources, events and agents.

18. A system architecture for entering and accessing entity data in events accounting, comprising:
a. a database, designed and configured to contain events accounting information;
b. a plurality of database tables, designed and configured to contain information pertaining to general entity events;
c. a set of composite events data, recorded within the database tables to represent composite accounting transactions; and
d. a set of component events data, recorded within the database tables to represent component transactions of the composite events data.
